(19) United States
(12) Patent Application Publication
(10) Pub. No.: US 2011/0061692 A1
(43) Pub. Date: Mar. 17, 2011

(54) FULL COVERAGE FLUIDIC OSCILLATOR WITH AUTOMATED CLEANING SYSTEM AND METHOD

(76) Inventors: Shridhar Gopalan, Westminster, MD (US); Gregory Russell, Catonsville, MD (US)

(21) Appl. No.: 12/518,033

(22) PCT Filed: Dec. 14, 2007
(86) PCT No.: PCT/US07/25579

§ 371 Date: Nov. 15, 2010

Related U.S. Application Data
(60) Provisional application No. 60/960,261, filed on Sep. 24, 2007.
(60) Provisional application No. 60/874,891, filed on Dec. 14, 2006.

(51) Int. Cl. B08B 9/00; B05B 7/04; B05B 17/04; B05B 1/08

(52) U.S. Cl. 134/169 R; 239/403; 239/11; 239/589.1

(57) ABSTRACT

A full coverage fluidic oscillator (2) includes a fluidic circuit member preferably having an oscillation inducing internal chamber, at least one inlet (8) or source of fluid under pressure, at least a pair of output nozzles (14, 16) connected to the source of fluid for projecting at least first and second impinging fluid jets into free space, where the first and second impinging jets collide or impinge upon one another at a selected jet angle to generate a substantially omni-directional sheet jet having selected thickness. The first and second jets are aimed at a pre-selected intersection point in free space where impingement is to occur. The sheet jet's thickness Δy is determined by the time-varying path or oscillation of each of the first and second impinging jets. The first and second impinging jets can be made to oscillate or pulsate by use of vortex generating amplifier structures (68, 70, 72, 149) within the internal chamber's fluid flow paths.

### PRIORITY CLAIMS AND REFERENCE TO RELATED APPLICATIONS

This application claims priority to related, commonly owned U.S. provisional patent application No. 60/874,891, filed Dec. 14, 2006, the entire disclosure of which is incorporated herein by reference. This application also claims priority to related, commonly owned U.S. provisional patent application No. 60/960,261, filed Sep. 24, 2007, the entire disclosure of which is also incorporated herein by reference.

### BACKGROUND OF THE INVENTION

1. Technical Field of the Invention

This invention relates to new methods and apparatus for distributing the flow of liquid from a spray device and to methods and apparatus for automated cleaning or disinfecting for structures or vessels having fluid-containing sidewalls.

2. Description of the Background Art

Fluidic inserts or oscillators are well known for their ability to provide a wide range of distinctive liquid sprays. The distinctiveness of these sprays is due to the fact that they are characterized by being oscillatory in nature, as compared to the relatively steady state flows that are emitted from standard spray nozzles.

For ease of construction, fluidic oscillators or inserts are generally manufactured as thin, rectangular members that are molded or fabricated from plastic so as to have especially-designed, liquid flow channels fabricated into either their broader top or bottom surfaces. They are typically inserted into the cavity of a housing whose inner walls are configured to form a liquid-tight seal around the insert's boundary surface which contains the especially-designed flow channels. Pressurized liquid enters such an insert and is sprayed from it. However, it should be noted that fluidic oscillators can be constructed so that their liquid flow channels are placed practically anywhere (e.g., on a plane that passes through the member's center) within the member's body; in such instances the fluidic would have a clearly defined channel inlet and outlet.

There are many well known designs of fluidic circuits that are suitable for use with such fluidic inserts. Many of these have some common features, including: (a) at least one power nozzle configured to accelerate the movement of the liquid that flows under pressure through the insert, (b) an interaction chamber through which the liquid flows and in which the flow phenomena is initiated that will eventually lead to the spray from the insert being of an oscillating nature, (c) a liquid inlet, (d) a pathway that connects the inlet and the power nozzle/s, and (e) an outlet or throat from which the liquid sprays from the insert.

Examples of fluidic circuits may be found in many commonly owned patents, including U.S. Pat. No. 3,185,166 (Horton & Bowles), U.S. Pat. No. 3,563,462 (Bauer), U.S. Pat. No. 4,052,002 (Stouffer & Bray), U.S. Pat. No. 4,151,955 (Stouffer), U.S. Pat. No. 4,157,161 (Bauer), U.S. Pat. No. 4,231,519 (Stouffer), which was reissued as RE 33,158, U.S. Pat. No. 4,508,267 (Stouffer), U.S. Pat. No. 5,035,361 (Stouffer), U.S. Pat. No. 5,213,269 (Srinath), U.S. Pat. No. 5,971,301 (Stouffer), U.S. Pat. No. 6,186,409 (Srinath) and U.S. Pat. No. 6,253,782 (Raghu), the entire disclosures of which are also incorporated herein by reference. This application is also commonly owned with U.S. patent application Ser. No. 10/979,032, filed Nov. 1, 2004, by the same inventors and describing structures for causing fluid jet oscillation in fluidic circuits, the entire disclosure of which is also incorporated herein by reference.

A key performance factor in many industrial applications for assorted spray devices, including fluidic oscillators, is the size of the area that the sprays from such devices can cover with liquid droplets—or alternatively, the lateral rate of spread of the fluid droplets as they proceed downstream. The degree of uniformity in the spatial distribution of these droplets can also be very important.

Spray from a fluidic oscillator spreads as it flows away from its origin at the oscillator's outlet (see FIG. 1), and the centerline of the jet or spray is defined to be in the x-direction and it exhibits both a lateral-horizontal spread in the x-y plane (referred to as the “width” of the spray and due primarily to the unique flow phenomena occurring within the insert that yields an essentially horizontally oscillating spray which is defined by a horizontal fan angle, φ, and a lateral-vertical spread in the x-y plane (referred to as the “thickness” or “throw” of the spray) which is defined by a vertical spread angle, θ.

As fluidic oscillators have continued to be used in more types of applications, the opportunity has arisen to re-examine and improve upon their design as a way to increase the lateral spreading characteristics of the sprays they emit so as to enable them to cover or wet larger areas or volumes. The results of applicant's research in this area and the inventions that have come from applicant's work are described herein.

Potential applications for fluidic oscillators having wide lateral spread include systems for automatically spraying or disinfecting a variety of surfaces. Household cleaning and commercial custodial cleaning include many tasks that people would rather postpone or avoid, such as cleaning the toilet bowl. Harsh chemicals have been employed in this cleaning task, and the results have often been noxious. Cleaning compositions which also provide a disinfecting or sanitizing effect are often used in the removal of stains and grime from surfaces in lavatory fixtures such as toilets, shower stalls, bathtubs, bidets, sinks, etc. Two types of commonly encountered stains in lavatories include “hard water” stains and “soap scum” stains. Surfaces with such stains may be found in homes, kitchens and hospitals, etc. Various compositions of cleaning agents and are known to the art and are generally suited for one type of stain but not necessarily for all stains. For example, it is known that highly acidic cleaning agents comprising strong acids, such as hydrochloric acids, are useful in the removal of hard water stains. However, the presence of strong acids is known to be an irritant to the skin and further offers the potential of toxicological danger. Other classes of cleaning compositions are known to be useful on soap scum stains, however, generally such compositions comprise an organic and/or inorganic acid, one or more synthetic detergents from commonly recognized classes such as those described in U.S. Pat. No. 5,061,393; U.S. Pat. No. 5,008,030; U.S. Pat. No. 4,759,867; U.S. Pat. No. 5,192,460; U.S. Pat. No. 5,039,441. Generally, the compositions described in these patents are claimed to be effective in the removal of soap scum stains from such hard surfaces and may find further limited use in other classes of stains. However, the formulations of most of the compositions within the aforementioned patents generally have relatively high amounts of acids (organic and/or inorganic) which raises toxicological concerns. One final consideration is that all of these formulations require someone to actually scrub the surface with a brush or other implement, while breathing the potentially toxic fumes produced during the cleaning process.

The prior art also includes automated deodorizing liquid dispensers (e.g., for use in urinals) or a variety of solid disk-shaped products intended to slowly dissolve in a toilet tank's water or in the bottom of a urinal, but those products do not offer adequate cleaning power and so provide an inadequate cleaning or disinfecting result. In an effort to improve cleaning effectiveness, U.S. Pat. No. 7,234,175 proposes use of a first liquid agent formulated to react with a second solid agent in the bowl, where the first liquid agent is mixed with flush water and the second solid agent to cleanse and deodorize the bowl, thereby requiring the user to provide and periodically replenish two cleaning agents. It also appears that the user must also periodically flush to provide cleansing fluid flow over whatever portion of the bowl's surface is reached by the mixed agents. All of these bowl cleaning methods have proven unsatisfactory, and so home-makers and custodians still clean toilet bowls by hand.

There is a need, therefore, for a convenient, inexpensive and unobtrusive automated system and method to clean, sanitize or disinfect structures or vessels having fluid-containing sidewalls such as toilet bowls and bidets.

### SUMMARY OF THE INVENTION

There has been summarized above, rather broadly, the prior art that is related to the present invention in order that the context of the present invention may be better understood and appreciated. In this regard, it is instructive to also consider the objects and advantages of the present invention.

It is an object of the present invention to provide novel methods for increasing the downstream areas that can be wetted by the flows that are emitted by stationary spray nozzles.

It is also an objective of the present invention to improve upon the spray performance of fluidic oscillators.

Another object of the present invention to overcome the above mentioned difficulties by providing a convenient, inexpensive and unobtrusive automated system and method to clean, sanitize or disinfect structures or vessels having fluid-containing sidewalls such as toilet bowls, bidets and sinks.

Yet another object of the invention is to provide an easily installed, unobtrusive, inexpensive system adapted for safe, unattended operation to clean toilet bowls.

In accordance with the method and structure of the present invention, applicant's research on the ways to increase the lateral spreading rates of liquid jets has yielded valuable insight on how to control and regulate such flows. A useful flow phenomenon was observed when the centerlines of the outputs from two steady, round jets were directed to lie in the same plane such that they have an included jet angle, Θ, and so that the jets intersect in ambient or free space, to impinge upon one another or collide and form a resultant spray. The resultant spray's droplets project or fly generally in the x direction and a y-z cross section of this spray at a point x₀ reveals that its length Δz is much greater than its width Δy.

Beyond the intersection where the jets impinge upon one another, the jets are seen to interact so as to spread rapidly in the plane that is perpendicular to the of the plane of the original jets—applicants call this resultant spray or downstream flow a “sheet jet” so as to reflect the change in cross-sectional shape of the jet from the cross section of the original round jets. In keeping with tradition, applicants say that the plane in which the jet is spreading most rapidly (i.e., here—x-z plane) has a characteristic fan angle, φ. Its rate of spread in the x-y plane is said to have a characteristic thickness angle, θ.

By imposing an instability on these impinging round jets (in the form of an oscillation of their flow about their centerlines), applicants have discovered that the resulting sheet jet will also oscillate about its x-axis so as to wet a much larger cross-sectional area at any downstream distance from the jet's origin. The thickness angle Θ for this oscillating sheet is greatly increased beyond that which was seen for the relatively steady state flow.

By causing the flow from the jets to oscillate about their centerlines in the x-y plane, the sheet jet is also seen to oscillate about the x-axis so as to wet a much larger y-z cross-sectional area at any downstream range or value of x. This is called a “full coverage” spray. One of the preferred embodiments of the device used to create the resultant sheet includes a member that has a flow channel which is molded into the interior of a fluid circuit. The fluidic circuit has an inlet and two branches, channels or legs which divide the inlet flow and direct divided flows to respective orifices at the distal end of each of the branches. The width of branches preferably decrease in cross sectional area as the orifice is approached so the branches to serve to accelerate the liquid that flows through them. The orifices can be circular in cross section and so shape round jets of fluid (but could also be square or rectangular to shape square, rectangular or thin linear/planar jets).

The front face of the member is concave or shaped such that the length or section between the opposing orifices is indented towards the inlet to a selected depth so that there is no wall section adjacent these orifices to which the jets that issue from them would be inclined to attach themselves. Thus, the fluid jets issuing from opposing orifices are referred to as “free” or unattached jet flows.

The centerlines of the orifices lie in the same plane and intersect at a “jet angle” Θ, where the jet intersection is in free space or in an ambient space.

Within the fluidic circuit, each branch optionally includes a sidewall defining a channel or fluid flow path including a sidewall segment with an inwardly projecting abrupt protrusion which serves to abruptly reduce the branch's cross sectional area, thereby throttling fluid flow around the protrusion and creating a separation region downstream the protrusion. A time-varying or unsteady flow vortex forms in the separation region downstream of protrusion.

The time-varying action of these vortices give the jets which issue from each orifice a time-varying deflection from the orifice's central axis, thereby generating the flows which impinge or collide to make an oscillating sheet.

Applicant's research with such flows has shown that the jet angle Θ is a major controlling factor in establishing the oscillating sheet's fan angle φ. For example, applicant has found that as the jets are made to effectively face each other (e.g., Θ goes to 170-180 degrees) that the fan angle goes to 360 degrees. Applicants also found that this device's jet angle Θ greatly impacts the size of the droplets in the resulting spray, with larger jet angles Θ yielding smaller sheet droplet sizes. Additionally, the amount of flow throttling or vorticity creation occurring in each of the branch flows affects the magnitude of the jet's oscillations and the resulting thickness angle θ of the oscillating sheet. If there is no throttling in the branch flows, it was observed that the downstream flow more closely resembles a substantially planar sheet flow with less thickness than was observed for branch flows from fluidic circuit structures including the vortex generating structures.

In accordance with an application-related aspect of the present invention, an automated toilet bowl cleaning system and method economically and safely provides substantially complete coverage of the bowl's interior surfaces by periodically spraying a uniform pattern of fine drops of a solution formulated for cleaning, disinfecting or sanitizing the bowl from a single nozzle assembly that is supplied with pressurized fluid flow from a powered pump. The powered pump is preferably housed with a battery power supply in a compact resilient housing that is adapted to attach or mount onto or near the toilet, and the pump is in fluid communication with the nozzle assembly via a flexible supply tube having a hollow interior lumen.

High pressure pumps use excessive energy and present possible safety issues, and so, in the present invention, a low operating pressure of approximately three (3) pounds per square inch (PSI) provides sufficient flow for a novel nozzle assembly to uniformly spray over substantially all of a three hundred sixty degree (360°) circular spray pattern, by virtue of a specially adapted fluidic circuit carried within a housing adapted to support the nozzle assembly and aim the spray pattern.

The nozzle assembly includes, preferably, an insert or fluidic circuit made from two parts and no moving parts, where the insert is received within the nozzle assembly's housing. The nozzle assembly occupies very little space in the bowl and so is conveniently mounted adjacent the bowl's rim. The battery powered pump and its housing also occupy very little package space, thereby making the entire system quick and easy to install in confined spaces.

Fluidic circuits and fluidic oscillators adapted to generate a spray in a sheet are known. To choose just one example, commonly owned U.S. Pat. No. 4,151,955 discloses a fluid dispersal device utilizing the Karman Vortex street phenomenon to cyclically oscillate a fluid stream before issuing the stream in a desired flow pattern. A chamber includes an inlet and outlet with an obstacle or island disposed therebetween to establish the vortex street. The vortex street causes the stream to be cyclically swept transversely of its flow direction in a manner largely determined by the size and shape of the obstacle relative to the inlet and outlet, the spacing between the obstacle and the outlet, the outlet area, and the Reynolds number of the stream. Depending on these factors, the flow pattern of the stream issued from the outlet may be (a) a swept jet, residing wholly in the plane of the device and which breaks up into droplets solely as a result of the cyclic sweeping, the resulting spray pattern forming a line when impinging on a target; or (b) a swept sheet, the sheet being normal to the plane of the device and being swept in the plane of the device, the resulting pattern containing smaller droplets than the swept jet pattern and covering a two-dimensional area when impinging upon a target.

While fluidic circuits have been adapted to generate spray patterns well suited for many applications (e.g., spraying windshields), they have not, before now, been adapted to spray substantially the entire peripheral interior surface of a vessel or bowl.

The new development provided by the nozzle assembly of the present invention is integration of a fluidic oscillator in a novel assembly that (for side feed embodiments) can spray over substantially all of a three hundred sixty degree (360°) circular pattern, by virtue of a specially adapted fluidic circuit integrally formed in the nozzle assembly. This new nozzle assembly generates first and second oscillating fluid jets that are each directed from opposing sides at a point of intersection. The first fluid jet and the second fluid jet collide to make a resultant spray pattern reaching even that portion of the bowl's surface that lies behind the nozzle assembly, from the perspective of the point of impingement.

The nozzle assembly's first and second impinging jets intersect at an angle referred to as a “jet angle”, and the jet angle is selected to provide an omni-directional spray pattern geometry with uniform coverage (around the bowl) and thickness (in vertical spray pattern cross section). The spray pattern is confined within the bowl, and does not extend above the bowl's interior surface, and so can be characterized as confined within an imaginary hemisphere, such that substantially no spray projects above the plane defining the bowl's upper circumferential edge.

Nozzle assembly embodiments optionally incorporate a rear feed configuration for receiving the pumped fluid, and therefore provide slightly less than full 360° coverage, since the nozzle assembly's housing and fluid feed structure block a small portion of the bowl's surface.

The cleaning system's pump is preferably battery powered and preferably includes a programmable controller or a timer programmed to periodically energize the pump and spray the bowl's interior surface with the fluid. The pump housing optionally includes or is in fluid communication with a reservoir containing the fluid selected for cleaning, deodorizing or sanitizing the toilet bowl and the energized pump draws the fluid into the pump's inlet and pumps the fluid into the supply tube at a selected low pressure of, e.g., 3 PSI. The fluid is fed from the supply tube into the nozzle assembly inlet, whereupon the fluid enters the fluidic oscillator's interior chamber, which defines first and second fluid flow paths terminating in opposing first and second output lumens to generate first and second oscillating fluid jets. As noted above, the first and second jets intersect or impinge on one another at a selected jet impingement angle to form a sheet spraying fluid droplets in an omni-directional pattern to wet substantially the entire interior surface of the bowl.

Since the first and second jets oscillate or alter direction in a manner that appears to be unstable, the intersection point where the impinging opposed jets collide changes or varies slightly over time, and so the resulting sheet has a vertical thickness.

The exterior shape or tapered sidewall geometry of the nozzle assembly's housing contributes to the flow of fluid behind or at the rear of the housing, and so the resulting sheet of spray can have 360° of coverage or somewhat less, where the nozzle assembly blocks only very little spray in the areas behind the nozzle assembly.

Varying the jet angle or angle of incidence for the first and second jets creates varying resultant spray patterns, and the applicants have found that a jet angle of approximately 160° creates a pattern of coverage having slightly more fluid flow in the front, toward the farthest portion of the bowl's interior (directly away from the nozzle assembly's mount or hook) for a more even application of the fluid around the bowl's interior.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 illustrates a coordinate system that is used to describe the three-dimensional, downstream development of liquid sprays.

FIG. 2 illustrates how two round jets whose centerlines lie in the same plane and intersect downstream can form a spray whose dimension or rate of spread in the plane perpendicular to that of the original plane is considerably larger than it is in this original plane; this downstream flow is identified as a sheet jet to express the change of cross-sectional shape that has occurred in the original round jets.

FIG. 3 illustrates the flow of phenomena that have been observed to occur when the original round jets are caused to oscillate about their centerlines—the resulting sheet jet is seen to oscillate about its x-axis so as to wet a much larger cross-sectional area at any downstream distance from the jet's origin.

FIG. 4 is a top view of a preferred embodiment of the fluidic circuit of present invention.

FIG. 5 is a top view of a second preferred embodiment of the fluidic circuit present invention.

FIG. 6 is a top view of a preferred embodiment of an improvement to the fluidic circuit previously disclosed in applicant's own U.S. patent application Ser. No. 10/979,032, in accordance with the present invention.

FIG. 7 is a top view of a second preferred embodiment of an improvement to the fluidic circuit previously disclosed in applicant's own U.S. patent application Ser. No. 10/979,032, in accordance with the present invention.

FIG. 8 illustrates the automatic bowl cleaning apparatus and method, in accordance with the present invention.

FIG. 9 is an exploded perspective view of one embodiment of the nozzle assembly for the automatic bowl cleaning apparatus of FIG. 8, in accordance with the present invention.

FIG. 10 illustrates, in plan view, one part of the “rear feed” embodiment of the nozzle assembly's fluidic oscillator, showing the orientation of the lumens configured for making the first and second jets, the filter, and the structural features dimensioned to generate the step amplifier oscillation, in accordance with the present invention.

FIG. 11 illustrates, in perspective and partial cross section, the rear feed embodiment the nozzle assembly, showing the direction of spray resulting of the from the impingement of the first and second jets and the structural features of the nozzle assembly's housing shaped to maximize the spray coverage angle to just under 360°, in accordance with the present invention.

FIG. 12 illustrates, in plan view, one part of the “side feed” embodiment of the nozzle assembly, showing the orientation of the lumens configured for making the first and second jets for a desired jet angle and sheet thickness, and the reversing chamber oscillation structural features, in accordance with the present invention.

FIG. 13 illustrates, in perspective and partial section, one part of the “side feed” embodiment of the nozzle assembly, showing the tapered depth of the fluid path in the output lumen, as well as the fluid flow path over the contoured exterior surface (1) to provide 360° coverage, in accordance with the present invention.

FIG. 14 is a distal end view of the nozzle assembly for the automatic bowl cleaning apparatus of FIGS. 8 and 9, in accordance with the present invention.

FIG. 15 is a partial cross section view of the nozzle assembly for the automatic bowl cleaning apparatus of FIGS. 8, 9 and 14, in accordance with the present invention.

FIG. 16 is a proximal end view of the nozzle assembly for the automatic bowl cleaning apparatus of FIGS. 8, 9, 14 and 15, in accordance with the present invention.

FIG. 17 is a narrow side view, in elevation, illustrating an embodiment of the oscillating jet fluidic circuit insert of FIGS. 8, 9, 14 and 15, in accordance with the present invention.

FIG. 18 is a broad side view illustrating the internal features (such as the inwardly projecting amplifiers) of the oscillating jet fluidic circuit insert of FIG. 17, in accordance with the present invention.

FIG. 19 is a broad side view of a flat-sheet (nearly zero thickness) omni-directional spray generating insert, illustrating the internal features of the non-oscillating jet fluidic circuit insert, in accordance with the present invention.

FIG. 20 illustrates the nozzle assembly housing of FIGS. 14-16 adapted to receive the fluidic circuit insert of FIGS. 17 and 18, in accordance with the present invention.

FIG. 21 illustrates a cross sectional view of the nozzle assembly housing of FIG. 20, along line A-A, in accordance with the present invention.

FIG. 22 illustrates a cross sectional view of the nozzle assembly housing of FIG. 21 along line C-C, in accordance with the present invention.

### DESCRIPTION OF THE PREFERRED EMBODIMENTS AND BEST MODES FOR CARRYING OUT THE INVENTION

Before explaining exemplary embodiments and methods of the present invention in detail, it is to be understood that the invention is not limited in its application to the details of construction and to the arrangements of the components set forth in the following description or illustrated in the Figures. The invention is capable of other embodiments and of being practiced and carried out in various ways. Also, it is to be understood that the phraseology and terminology employed herein are for the purpose of description and should not be regarded as limiting.

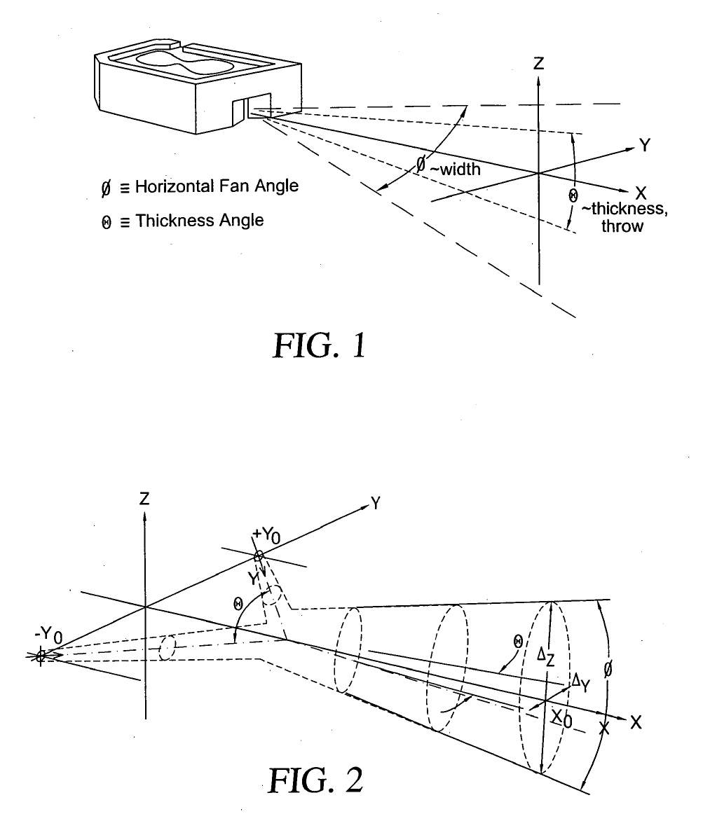

As noted above, FIG. 1 provides a frame of reference and spray from a fluidic oscillator spreads as it flows away from its origin at the oscillator's outlet. The centerline of the jet or spray is defined to be in the x-direction and it exhibits both a lateral-horizontal spread in the x-y plane (referred to as the “width” of the spray and due primarily to the unique flow phenomena occurring within the insert that yields an essentially horizontally oscillating spray which is defined by a horizontal fan angle, φ, and a lateral-vertical spread in the x-y plane (referred to as the “thickness” or “throw” of the spray) which is defined by a vertical spread or “thickness” angle, θ. In the example illustrated in FIGS. 1, φ=90° and θ=1.5° and so this is referred to as an effective planar jet that has a large horizontal rate or angle of spread as it proceeds downstream, or outwardly away from the jet intersection where impingement occurs.

Applicant's research on the ways to increase the lateral spreading rates of liquid jets has yielded valuable insight on how to control and regulate such flows. For example, the diagram of FIG. 2 illustrates the flow phenomena that applicant has observed when aiming or directing the centerlines of the jet outputs from two steady, round jets (note: these initial jets could also have been square, planar, etc.) to lie in the same (e.g., x-y) plane such that they have an included jet angle, Θ, and so that the jets intersect downstream.

In FIG. 2, first and second converging round jets are shown in the x-y plane and intersect, impinge or collide in free space (i.e., not within a chamber) to form a resultant spray the proceeds or flows generally in the x direction. A y-z cross section of this resultant spray at a point x₀ reveals that its length Δz is much greater than its width Δy.

Beyond the intersection where the jets impinge upon one another, the jets are seen to interact so as to spread rapidly in the plane that is perpendicular to the of the plane of the original jets—applicants call this downstream flow a “sheet jet” so as to reflect the change in cross-sectional shape of the jet from the cross section of the original round jets. In keeping with tradition, applicants say that the plane in which the jet is spreading most rapidly (i.e., here—x-z plane) has a characteristic fan angle, φ. Its rate of spread in the x-y plane is said to have a characteristic thickness angle, θ.

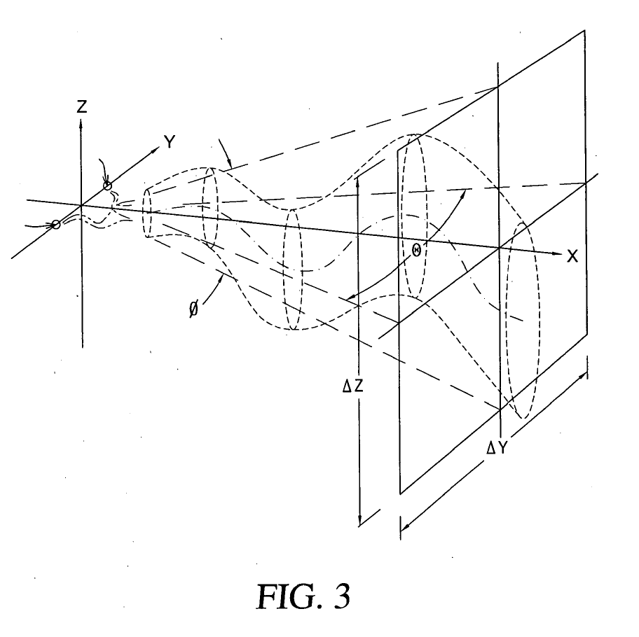

By imposing an instability on these round jets (in the form of an oscillation of the impinging jets' flow about their respective centerlines), applicants have discovered that the resulting sheet jet will also oscillate about its x-axis so as to wet a much larger cross-sectional area at any downstream distance from the jet's origin (see FIG. 3). The thickness angle Θ for this oscillating sheet is greatly increased beyond that which was seen for the relatively steady state flow, as seen in FIG. 2.

Referring again to FIG. 3, by causing the flow from the jets to oscillate about their centerlines in the x-y plane, the sheet jet is also seen to oscillate about the x-axis so as to wet a much larger y-z cross-sectional area at any downstream value of x. This is called a “full coverage” spray.

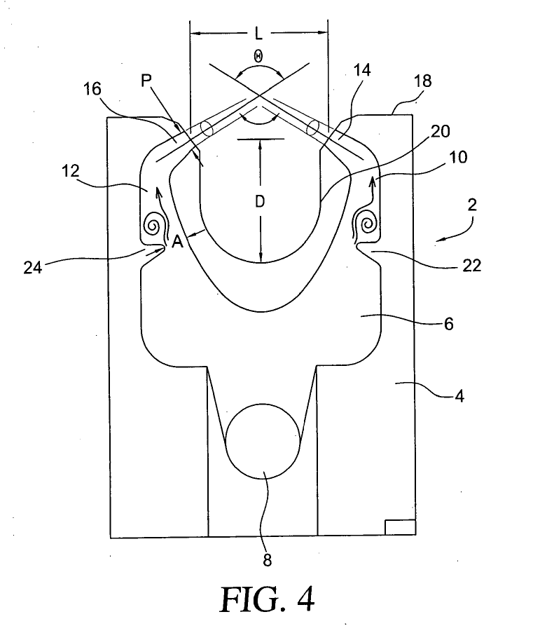

One of the preferred embodiments of the device used to create the FIG. 3 flow is illustrated in FIG. 4. This is a top view (note: this could also be the cross-sectional view of a member that has a flow channel which is molded into the member's interior) of a member 2 whose top surface 4 has molded into it a fluid circuit 6. This circuit has an inlet 8 and two branches or legs 10, 12 which divide the inlet flow and direct divided flows to respective orifices 14, 16 at the end of each of the branches. The width of branches 10 and 12 are each seen to decrease in cross sectional area as the orifice is approached so the branches to serve to accelerate the liquid that flows through them. The orifices 14, 16 illustrated in this exemplary embodiment are circular in cross section and so shape round jets of fluid (but could also be square or rectangular to shape square, rectangular or thin linear/planar jets) which have a characteristic dimension of P.

The front face 18 of this member 2 is shaped such that the length or section 20 between the opposing orifices 14, 16 is intended towards the inlet 8 to a depth of D so that there is no wall section adjacent these orifices to which the jets that issue from them would be inclined to attach themselves. Thus, the fluid jets issuing from opposing orifices 14 and 16 are referred to as “free” or unattached jet flows.

The centerlines of the orifices 14, 16 are seen to lie in the same plane and to intersect at a “jet angle” Θ. The distance between the orifices (e.g., 2.905 mm) is denoted as L (as seen in FIGS. 4 and 18).

Branch 10 is a fluid conveying channel and defines a fluid flow path including a sidewall segment with an inwardly projecting abrupt protrusion 24 which serves to abruptly reduce the branch's cross sectional area A and to throttle fluid flow around the protrusion, thereby creating a separation region downstream the protrusion 24. A time-varying or unsteady flow vortex forms in the separation region downstream of protrusion 24. Branch 12 defines a similar fluid conveying channel or fluid flow path including a sidewall segment with an inwardly projecting abrupt protrusion 22 which serves to abruptly reduce the branch's cross sectional area and to throttle fluid flow around the protrusion, thereby creating a separation region downstream the protrusion 22. Here again, a time-varying or unsteady flow vortex forms in the separation region downstream of protrusion 22.

The time-varying action of these vortices give the jets which issue from each orifice 14, 16 a time-varying deflection from the orifice's central axis, thereby generating the flows which impinge or collide to make an oscillating sheet. The characteristic dimension of each of these throttled areas is denoted as A.

Applicant's research with such flows has shown that the jet angle Θ is a major controlling factor in establishing the oscillating sheet's fan angle φ. For example, applicant has found that as the jets are made to effectively face each other (i.e., Θ goes to 170-180 degrees) that the fan angle goes to 360 degrees. Applicants also found that this device's jet angle Θ greatly impacts the size of the droplets in the resulting spray, with larger jet angles Θ yielding smaller droplet sizes. Additionally, applicant found that the amount of flow throttling or vorticity creation occurring in each of the branch flows affects the magnitude of the jet's oscillations and the resulting thickness angle θ of the oscillating sheet. If there is no throttling in the branch flows for the embodiment shown in FIG. 4, it was observed that the downstream flow more closely resembles the flow shown in FIG. 2 than that shown in FIG. 3.

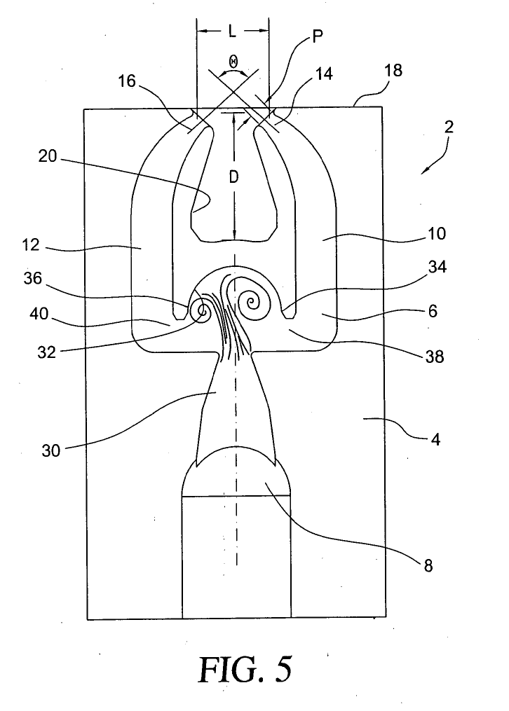

It should be noted that there are many other ways to introduce such periodic instabilities in the jets which flow from devices that are similar to that shown in FIG. 4. For example, shown in FIG. 5 is a top view of a second preferred embodiment of the present invention. Again, it can be seen that we have a member 2 whose top surface 4 has molded into it a fluid circuit 6. This circuit has an inlet 8 and two branches or legs 10, 12 which divide the inlet flow and direct it to an orifice 14, 16 that lies at the end of each of these branches. The width of these branches is seen to decrease in size as its orifice is approached so as to allow the branches to serve to accelerate the liquid that flows through them. The orifices shown here take the shape of round jets (note: they could just as easily be square, rectangular or planar jets) which have a characteristic dimension of P.

The front face 18 of this member 2 is shaped such that the length or section 20 between these orifices is indented towards the inlet 8 to a depth of D so that there is no wall section adjacent these orifices to which the jets that issue from them would be inclined to attach themselves. Thus, what effectively issues from these orifices are what we call “free” jet flows.

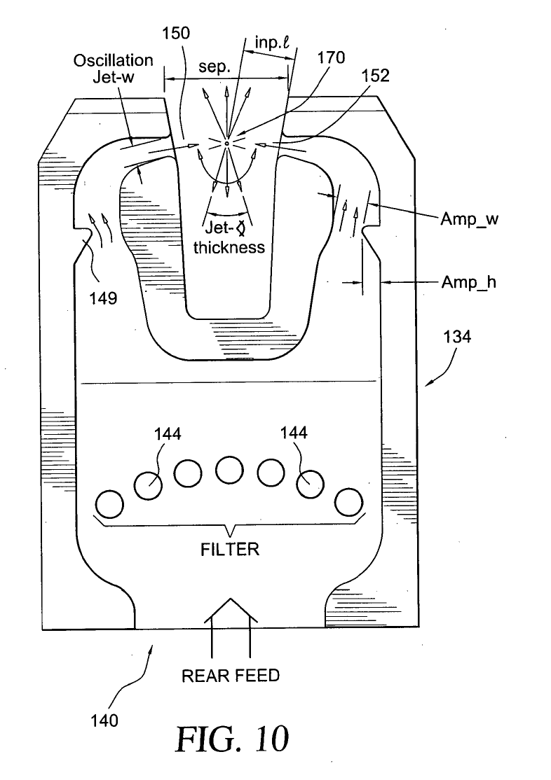

The centerlines of these orifices 14, 16 are seen to lie in the same plane and to intersect at what we call the jet angle, Θ. The distance between the orifices is denoted as L (in FIG. 4) and “sep” (in FIG. 10).

Between the inlet 8 and the branches 10, 12 is a power nozzle 30 which is characterized by its decrease in cross-sectional area as the liquid flows further along the nozzle; this decrease serving to accelerate the liquid that flows through it.

The portion of the fluid circuit that is proximate the point, where the extended centerline of the power nozzle is seen to intersect with the boundary wall 32 that is opposite it, is seen to take the shape of an inverted U whose ends 34, 36 approach the power nozzle so as to form flow entries 38, 40 into the branches 10, 12. This portion is configured in this manner so that unsteady vortices will be created in this region (see FIG. 5) which serves to create a periodic increase and decrease in the rate at which liquid is introduced into the branches. This flow phenomenon is again seen to create the previously described oscillations of the sheet jet that is formed by the intersection of the now oscillating free jets that flow from the branch orifices 14, 16.

Different fluidic oscillators using interacting jets are described in, for example, U.S. Pat. No. 6,253,782 and U.S. patent application Ser. No. 10/979,032, both having the same Assignee as the present invention. However, the previous fluidic oscillators had jet interactions occurring within interaction chambers that defined part of the oscillator's fluidic circuit and which were located upstream of the oscillator's throat/outlet(s) and any expansion section that the oscillator might have.

The present invention is seen to be configured differently, causing impinging jet intersections to occur totally outside the oscillator's outlet or expansion section, in free space or in an ambient environment. This can be contrasted with that of the invention disclosed in U.S. patent application Ser. No. 10/979,032 which had the jet intersections occurring proximate the oscillator's outlets and in the vicinity of the oscillator's expansion section.

Applicant's most recent research suggests that the same upstream disturbances that are used in the present invention, or one similar to them, might also be used in the “thick/three-dimensional” oscillator of U.S. patent application Ser. No. 10/979,032 to further improve upon that oscillator's ability to laterally spread the spray which it emits.

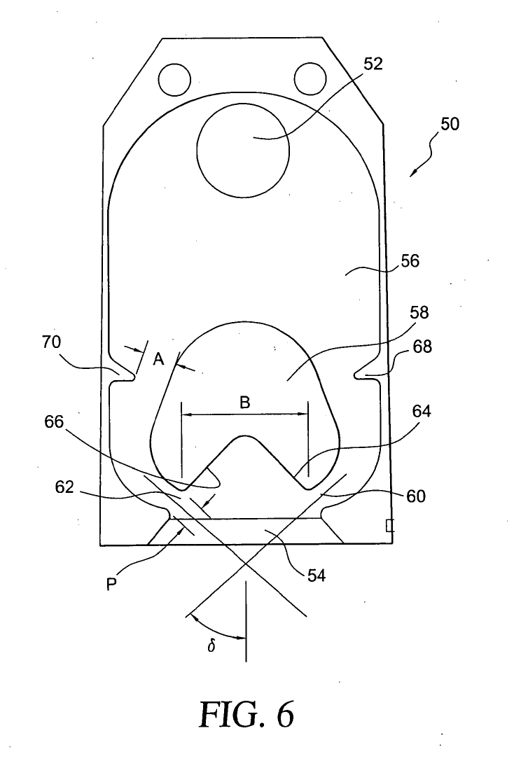

Turning now to FIG. 6, the top view of a fluidic oscillator 50 (similar to U.S. patent application Ser. No. 10/979,032) is characterized by having a fluidic circuit located within the member's top surface (note: this could also be the cross-sectional view of a member that has a flow channel which is molded into the member's interior). The fluidic circuit used in this application has an inlet 52, an outlet 54, a channel 56 whose floor and sidewalls define a fluid passage connecting the inlet and outlet, and a barrier 58 located proximate the outlet that rises from the channel floor, with the barrier configured such that:

(i) barrier 58 divides the channel in the region of the barrier into what are herein denoted as first and second co-planar power nozzles 60, 62

(ii) each of the nozzles 60, 62 have a distal end downstream portion whose cross section is characterized by a characteristic length P and the angle that a centerline projecting normal to this cross section makes with the member's centerline,

(iii) the barrier 58 having a width that is characterized by the length B between the power nozzles' distal end downstream portions, and

(iv) barrier portion 64 between the power nozzles is indented towards the oscillator's inlet so that the boundary surface 66 in this region is pulled back from the issuing jets' centerlines to cause flow separation in this region.

This flow separation region is seen to promote the formation of unsteady vortices in this region. These serve to cause the resulting sheet jet formed by the jets to have significant lateral motions and to yield a comparatively large thickness angle, θ, for the resulting sheet jet.

It should also be noted that the oscillator shown in FIG. 6 has been improved upon from that disclosed in U.S. patent application Ser. No. 10/979,032 by the addition to the outer sidewalls on either side of the barrier of inwardly projecting abrupt protrusions 68, 70 whose characteristic dimension is denoted as A. Inwardly projecting protrusions 68, 70 serve to throttle the flow around each of the protrusions and to create a flow separation region downstream of each of the protrusions. Unsteady flow vortices are seen to form in each of these separation regions. The action of these vortices is seen to give the jets which issue from each orifice and the oscillation sheet which they form downstream even more thickness spread. Additionally, the resulting flows from this oscillator are also seen to exhibit a more uniform spatial distribution of smaller droplets in the downstream portions of its sprays.

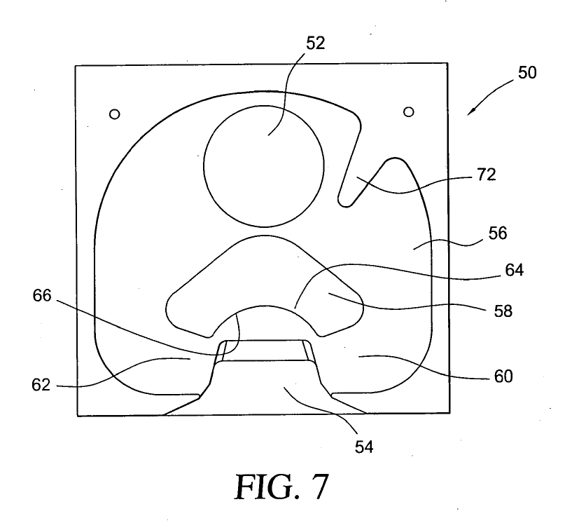

Another embodiment which presents another method of generating the upstream flow disturbances necessary to increase the resulting sheet jet's rate of thickness spread is illustrated in FIG. 7. This embodiment is seen to have a single offset inwardly projecting protrusion 72 extending from a sidewall proximate the inlet 52. Large, abrupt protrusion 72 also serves to throttle the fluid's flow so as to create a flow separation region downstream of the protrusion, as fluid flows in via inlet 52 and flows toward nozzles 60, 62. Unsteady flow vortices are seen to form in the protrusion's separation region which causes the flow from the power nozzle 60 on the nearest side of the fluidic to exhibit the greater vorticity, ultimately resulting in the oscillation of a resulting the sheet jet that is formed downstream. The oscillations result in the flow from this fluidic exhibiting ever greater thickness spread.

It will be appreciated by those of skill in the art that the full coverage fluidic oscillator embodiments of FIGS. 3-7 employ branch vortex inducing structures such as an inwardly projecting protrusions (e.g., 22, 24, 68, 70 and 72) configured to throttle the flow of fluid through branch by creating a separation region downstream of the protrusion, where the branch's fluid flow is thereby forced to oscillate or yaw such that the fluid jet oscillates about that fluid jet's central steady state axis. The full coverage fluidic oscillator thereby causes a time varying shift in the jet and the resultant full coverage sheet jet has a selected thickness angle, where the sheet jet's thickness angle is controlled in response to at least one of first fluid jet oscillation amplitude and second fluid jet oscillation amplitude.

The gap between the amplifier (e.g., 22, 24, 68, 70 and 72) and the wall (amp_gap) can be used to control the thickness angle of the resultant spray. For an amp_gap to power nozzle width ratio of 1.57, the spray thickness is about 10-15 deg. Increasing the amp_gap to power nozzle width ratio decreases the resultant spray's thickness, but can also make the resultant spray less uniform or consistent. Decreasing the amp_gap to power nozzle width ratio increases the resultant spray's thickness up to about 25 deg by increasing the vorticity upstream of the jet, increasing the jet's instability.

Further increases in resultant spray thickness (up to 75 deg) is achieved by moving the jet interaction within the nozzle, so that the interaction region is bounded by nozzle walls as in FIG. 6.

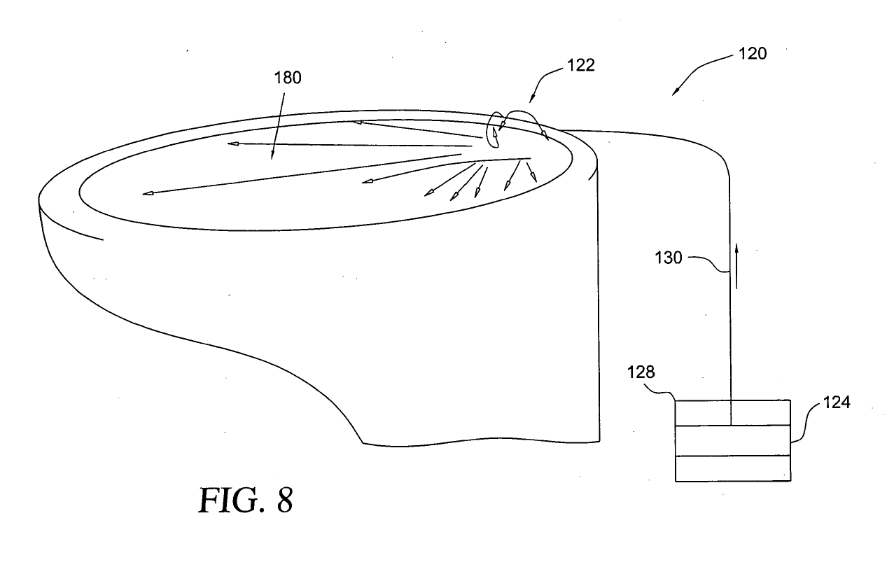

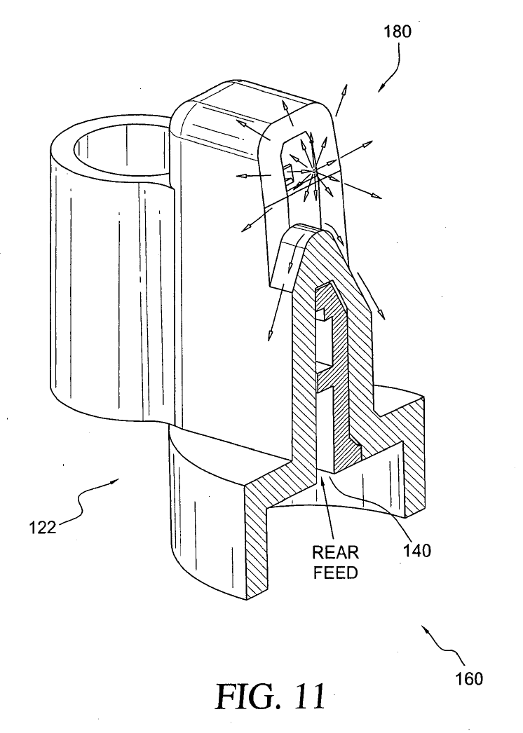

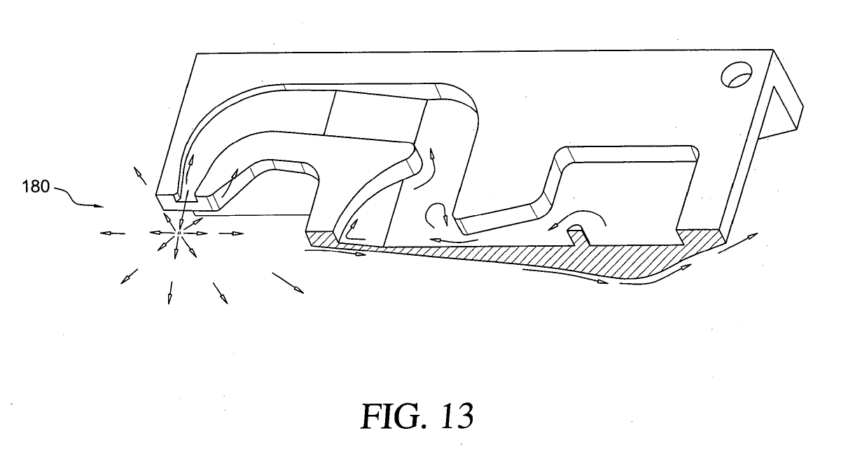

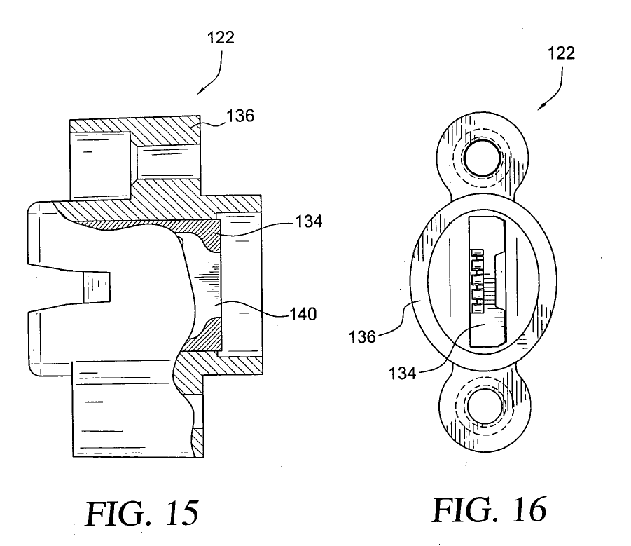

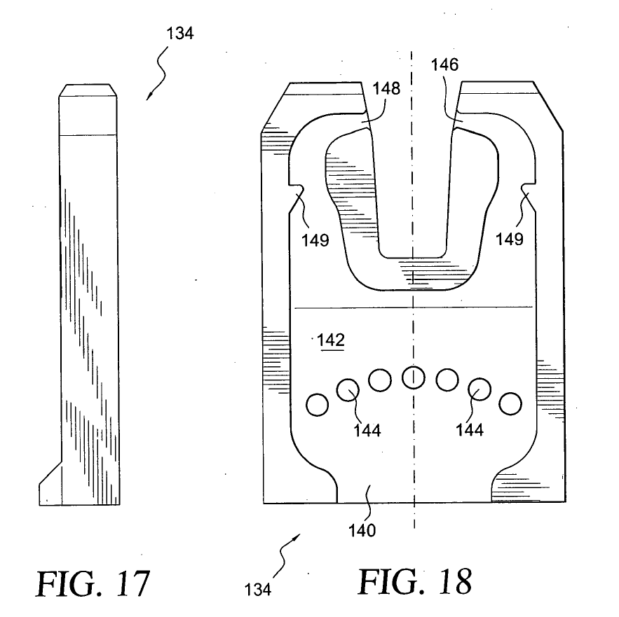

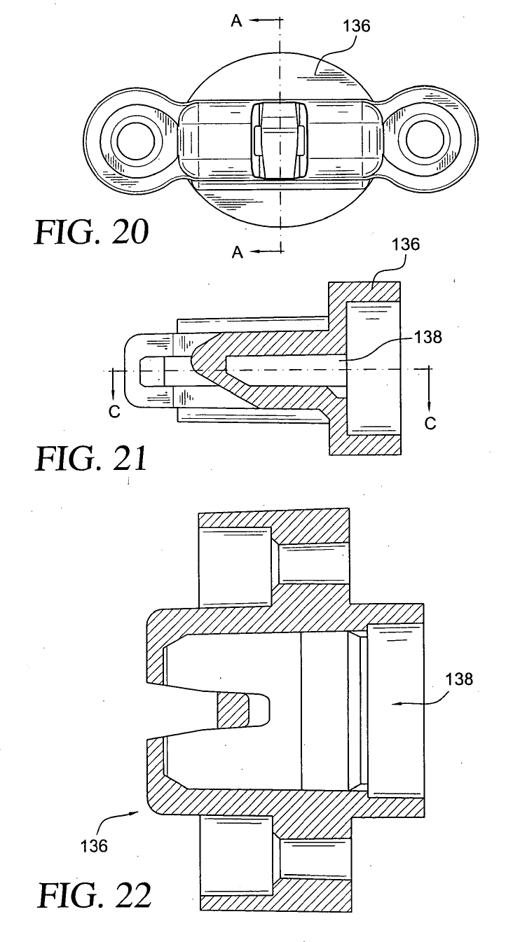

Turning now to the embodiments illustrated in FIGS. 8-20, an automated toilet bowl cleaning system 120 and the method of the present invention economically and safely provides substantially complete cleaning coverage of a standard toilet bowl's interior hemispherical surface by periodically spraying a uniform pattern of fine drops (preferably 300-400 microns VMD) of a solution formulated for cleaning, disinfecting or sanitizing the bowl from a single nozzle assembly 122 that is supplied with pressurized fluid flow from a pump 124. Pump 124 is preferably battery powered and housed in a compact resilient housing 128 configured to attach or mount onto or near the toilet 126. Pump 124 is in fluid communication with nozzle assembly 122 via a flexible supply tube 130 having a hollow interior lumen. Spray velocity when pump 124 is activated is low enough to result in a “soft spray” that prevents splatter or splashing from the bowl's surface.

High pressure pumps use excessive energy and present possible safety issues, and so, in the present invention, a low operating pressure of approximately three (3) pounds per square inch (PSI) is generated at the outlet of pump 124. With that low pressure, nozzle assembly 122 is advantageously configured to uniformly spray over substantially all of a three hundred sixty degree (360°) circular spray pattern, by virtue of a specially adapted insert or fluidic circuit 134 received in a socket 138 integrally formed in a nozzle assembly housing 136. Housing 136 supports and aims the nozzle assembly's spray generating components.

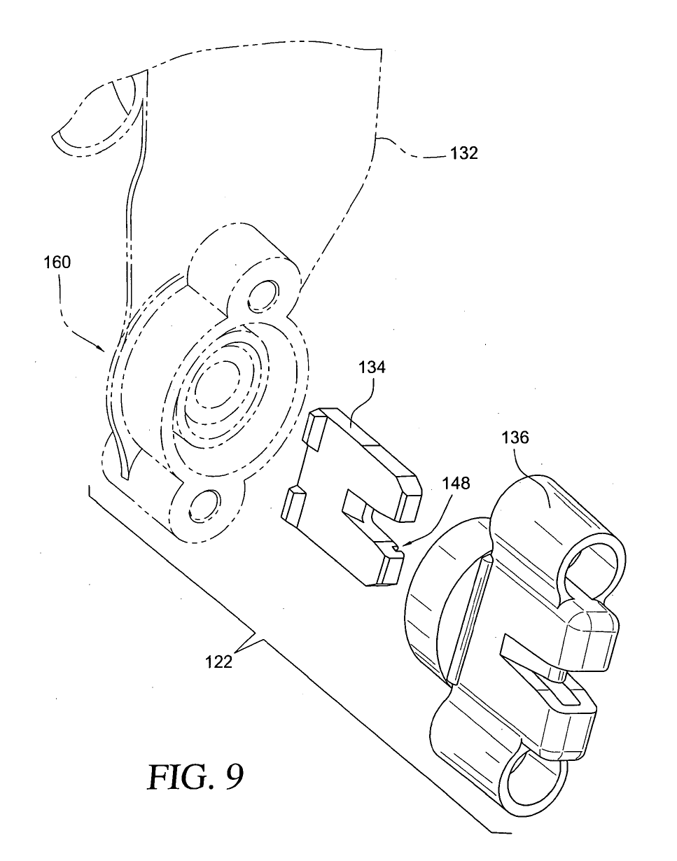

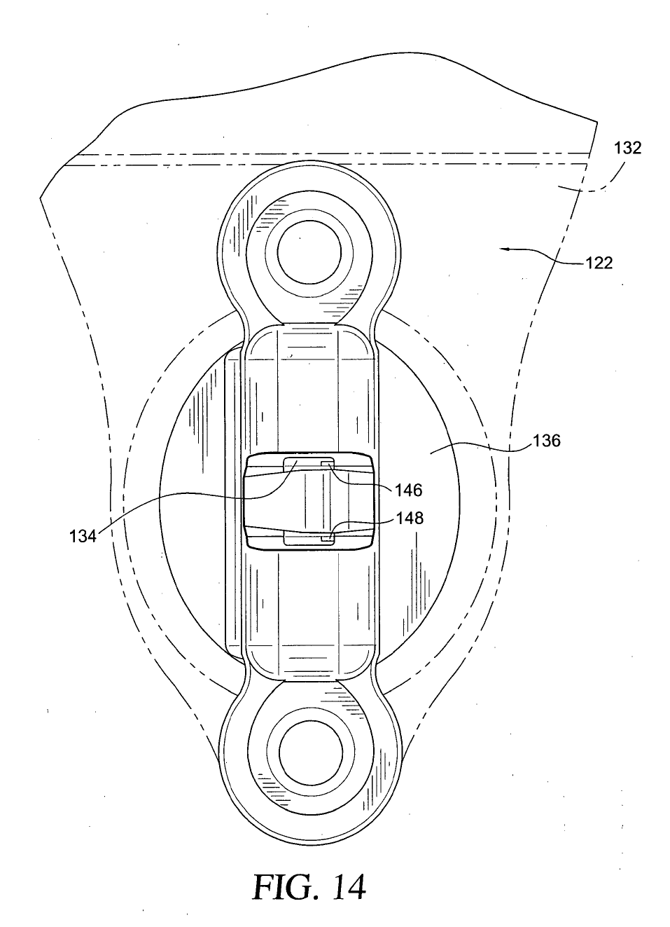

Nozzle assembly 122 includes, preferably, an oscillating jet fluidic circuit 134 that has no moving parts. The nozzle assembly occupies very little space in the bowl and so is conveniently mounted adjacent the bowl's rim, preferably by a resilient polymer hook (best seen in FIGS. 9 and 14). The battery powered pump's housing 128 also occupies very little package space, thereby making the entire system quick and easy to install in confined spaces.

As noted above, fluidic circuits and fluidic oscillators adapted to generate a spray in a sheet are known, and commonly owned U.S. Pat. No. 4,151,955 discloses a fluid dispersal device utilizing the Karman Vortex street phenomenon to cyclically oscillate a fluid stream before issuing the stream in a desired flow pattern. A chamber includes an inlet and outlet with an obstacle or island disposed therebetween to establish the vortex street. The vortex street causes the stream or jet to be cyclically swept transversely of its flow direction in a manner largely determined by the size and shape of the obstacle relative to the inlet and outlet, the spacing between the obstacle and the outlet, the outlet area, and the Reynolds number of the stream. Depending on these factors, the flow pattern of the stream issued from the outlet may be (a) a swept jet, residing wholly in the plane of the device and which breaks up into droplets solely as a result of the cyclic sweeping, the resulting spray pattern forming a line when impinging on a target; or (b) a swept sheet, the sheet being normal to the plane of the device and being swept in the plane of the device, the resulting pattern containing smaller droplets than the swept jet pattern and covering a two-dimensional area when impinging upon a target.

While fluidic circuits have been adapted to generate spray patterns well suited for many applications, such as when spraying planar target areas like windshields, they have not, before now, been adapted to spray substantially the entire peripheral wall interior surface of something like a bowl.

Nozzle assembly 122 differs from the prior art in that the fluidic circuit's inlet 140 receives the cleaning fluid at the selected low pressure (e.g., 3 P.S.I.) and the fluid then flows into and through interior chamber 142 having a plurality of obstacles or islands (e.g., filter posts 144) along a fluid flow path of varying cross sectional area, terminating distally in a first and second outlets or output lumens, 146, 148.

In the embodiments illustrated in FIGS. 10 and 18, first output lumen 146 and second output lumen 148 each have an inwardly projecting tapered protrusion, obstacle or amplifier 149 defined in the lumen sidewall. Amplifiers 149 cause jet instabilities resulting in varying thickness in the spray, as well as uniformly varying or oscillating angular displacement, with respect to the output lumen's central axis (described in more detail, below). The present inventors are also inventors for commonly owned U.S. patent application Ser. No. 10/979,032, filed Nov. 1, 2004, which describes the features and effect of structures like amplifier 149, and, as noted above, the entire disclosure of that application is incorporated herein by reference.

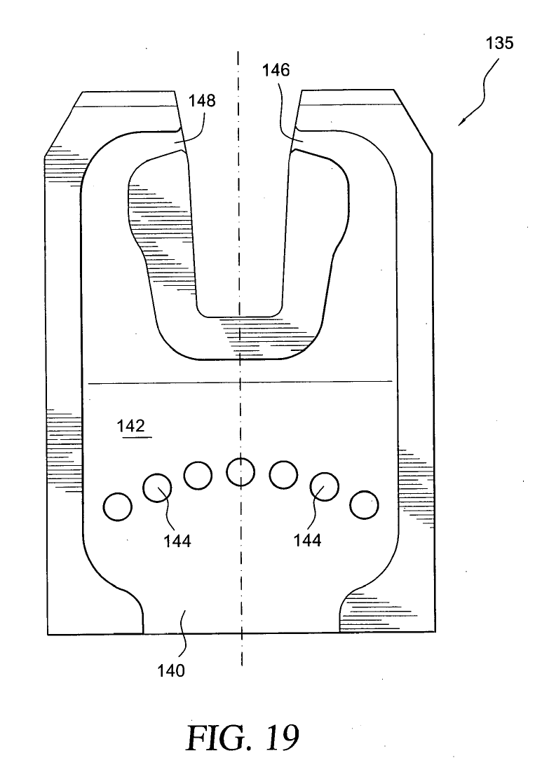

In an alternative embodiment illustrated in FIG. 19, a non-oscillating jet fluidic circuit 135 lacks the amplifier obstacles designed to induce oscillation in the opposing fluid jets, and so the impinging fluid jets do not vary or oscillate in thickness or angular offset, thereby colliding to generate a substantially omni-directional spray pattern with almost no thickness, effectively generating a sheet spray pattern. This embodiment is believed to be less effective for cleaning, but is still within the scope of the present invention.

When fluid is pumped into nozzle assembly 122, that fluid flow is divided into a first oscillating output fluid stream or jet, from first output lumen 146 and a second oscillating output fluid stream or jet, from second output lumen 148.

The new development provided by nozzle assembly 122 is integration of a fluidic circuit in a novel assembly that (for side feed embodiments) can spray over substantially all of a three hundred sixty degree (360°) circular spray pattern, by virtue of a specially adapted oscillating jet fluidic circuit 134. Nozzle assembly 122 creates and aims first fluid jet 150 in a selected direction to impinge upon opposing second fluid jet 152. First jet 150 and second jet 152 each oscillate about a central fluid jet axis and impinge or collide against one another to make a resultant circular horizontal spray pattern aligned with a horizontal plane that is substantially parallel to the toilet bowl's rim when the system is mounted. The resulting circular spray pattern reaches even that portion of the bowl's surface that lies behind the nozzle assembly, from the perspective of the point of impingement of the jets.

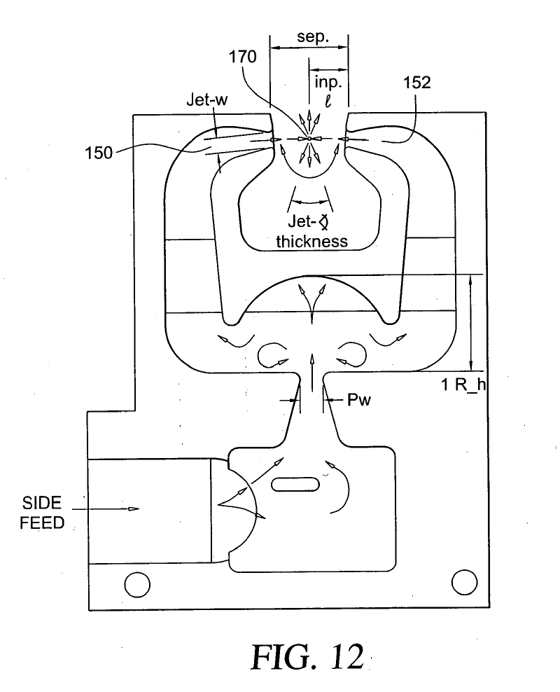

Nozzle assembly 122 generates the first and second impinging or intersecting oscillating fluid jets at an angle of intersection for the jets (or “jet angle” as shown in FIGS. 10 and 12) selected to provide a spray pattern geometry with uniform coverage (around the bowl) and thickness (in vertical spray pattern cross section), and as best seen in FIG. 1, the impinging jets 150, 152 result in a spray pattern 180 that is confined within the bowl of toilet 126. Spray pattern 180 does not extend above the bowl's interior surface, and so can be characterized as confined within an imaginary hemisphere, such that substantially no spray projects above the plane defining the bowl's upper circumferential edge.

The nozzle assembly embodiments shown in FIGS. 9-11 and 14-19) incorporate a “rear feed” configuration for receiving the pumped fluid, and therefore provide slightly less than full 360° coverage.

Cleaning system 120 preferably includes battery powered pump, but the power supply for pump 124 can include a conventional AC power supply adapted for connection to a standard outlet. Pump 124 is configured with a programmable controller or a timer programmed to periodically energize the pump and spray the bowl's interior surface with the fluid, without requiring the presence of a person. Pump 124 is also optionally activated in response to a manual control input, such as a switch (e.g., a momentary contact, normally open switch). Pump housing 128 optionally includes or is in fluid communication with a reservoir containing a fluid selected for cleaning, deodorizing or sanitizing the toilet bowl and the energized pump draws the fluid into the pump's inlet and pumps the fluid into supply tube 130 at a selected low pressure of, e.g., 3 PSI. The fluid fed from supply tube 130 into the nozzle assembly inlet 160, whereupon the fluid enters the fluidic oscillator's interior chamber 142, which defines first and second fluid flow paths terminating in first output lumen 146 and opposing second output lumen 148 to generate first and second oscillating fluid jets 150, 152. First and second jets 150, 152 intersect or impinge on one another at a selected jet impingement angle (“Jet [symbol] ”) to form the sheet spraying fluid droplets in every direction to wet substantially the entire interior surface of the bowl.

Since first jet 150 and second jet 152 each oscillate or alter direction in a time-varying manner that appears to be unstable, the intersection point 170 where the impinging opposed jets collide changes or varies slightly over time, and so the resulting sheet 180 has a vertical thickness.

The exterior shape of geometry of the nozzle assembly 122 contributes to the flow of fluid behind or at the rear of the nozzle assembly housing 128, and so the resulting sheet of spray 180 can have 360° of coverage or somewhat less, where the nozzle assembly 122 blocks some spray in the areas behind the nozzle assembly.

The jet angle (“Jet [symbol] ”) is defined as the angle of incidence for each of the first and second jets, and the applicants have found that a jet angle of 180° creates a substantially uniform pattern of coverage, meaning that fluid flow is substantially equal in every direction around the bowl, while an angle of less than 180° moves more fluid flow toward the front (directly away from nozzle assembly 122) and an angle of more than 180° moves more fluid flow toward the rear (directly at or behind nozzle assembly 122). The applicant's experiments have lead them to choose a jet angle of approximately 160°, to create a pattern of coverage having slightly more fluid flow in the front, toward the farthest portion of the bowl's interior (directly away from the nozzle assembly's mount or hook 132).

The applicants have also discovered that the nozzle assembly's first and second output lumens have to be spaced apart from one another or separated by a selected separation (“Sep” as shown in FIG. 12) and Sep must be adjusted with Jet angle to maintain an effective impact length (“imp L” as shown in FIG. 12). In applicant's development work to date, the preferred impact length or “imp L” is approximately three times the Jet width (“Jet W” as shown in FIG. 12). The nozzle assembly's first and second output lumens each have, at their respective distal ends, a substantially square orifice with a selected cross sectional area and square side length. Once beyond the orifice, the jet is modeled as a cylinder of fluid having a substantially circular cross section, and the jet width “Jet W” is a diameter substantially equal to the output lumen's orifice square side length (see FIG. 12). This description characterizes the fluid jet as if it were not oscillating in angular deflection from the central axis of the output lumen, for purposes of explanation. In fact, these alignments represent the mean position of the oscillating fluid jet over time, and the long term or steady state position of the jet's central axis is characterized as being substantially coaxially aligned with the central axis of that jet's output lumen, for purposes of this explanation.

The components of nozzle assembly 122, including housing 136, oscillating jet insert 134 and non-oscillating jet insert 135 may be manufactured from any resilient, durable material customarily used in making fluid handling or plumbing components such as durable plastics or metals. The dimensions shown in FIGS. 14-22 are in millimeters, unless otherwise noted.

Generally speaking, it will be appreciated by those having skill in the art that the present invention makes it possible to use a single static or non-moving nozzle assembly having no moving parts to automatically generate a spray that will wet the entire interior surface of a substantially hemispherical bowl or vessel, when fed fluid from a low pressure source.

In the broadest terms, cleaning system 120 is an automated system for unattended cleaning of the interior surface of a structure such as the interior of the bowl for a toilet 120, and includes:
(a) a pump 124 configured to provide pressurized fluid at low pressure; (b) pump 124 being configured to be energized or actuated in response to a control signal from a timer or programmable controller;
(c) a single, static or non-moving nozzle assembly 122 adapted to be mounted within the rim of the toilet's bowl, proximate the bowl's upper circumferential rim, to hang above the bowl's interior surface (e.g., by hook 132), but in a position likely to be hidden by a toilet seat, when lowered;
(d) wherein nozzle assembly 122 further comprises:

(i) an insert or body member 134 or 135 (preferably oscillating jet insert 134) having a chamber 142 therein, said chamber having a fluid inlet 140 for receiving fluid under pressure and admitting it into said chamber and first and second fluid outlets 146, 148 for issuing first and second pressurized fluid jets 150, 152 from chamber 142 into an ambient environment, said inlet 140 and said first and second outlets 146, 148 defining first and second flow paths therebetween for flow of fluid through said chamber;

(ii) and when using oscillating jet insert 134, oscillation-inducing means 149 for causing the fluid jets 150, 152 issued from said first and second outlets to oscillate about their respective central axes, said oscillation-inducing means comprising surface means disposed in said flow paths and responsive to fluid from said inlet impinging thereon for establishing alternating vortices in said fluid downstream of said surface means; and

(iii) wherein said first pressurized fluid jet 150 and said second pressurized fluid jet 152 are aimed from opposing directions toward an intersection or impingement point 170 at a jet angle of less than 180° to generate an oscillating sheet or resultant spray 180 having a selected thickness or angular extent, such that the resultant spray is substantially omni-directional and wets substantially all the bowl's interior surface from the non-moving single nozzle assembly 122.

Having described preferred embodiments of a new and improved method and apparatus, it is believed that other modifications, variations and changes will be suggested to those skilled in the art in view of the teachings set forth herein. It is therefore to be understood that all such variations, modifications and changes are believed to fall within the scope of the present invention as set forth in the claims.

What is claimed is:

1. A full coverage fluidic oscillator comprising:
a fluidic circuit having an a fluid inlet and first and second branches configured to divide fluid flowing into said inlet into first and second branches, wherein said first branch terminates distally in a first orifice and said second branch terminates distally in a second orifice;
wherein at least one of said branches optionally includes an oscillation inducing or vortex inducing structure;
said first branch being configured to project a first fluid jet along a first fluid jet axis;
said second branch being configured to project a second fluid jet along a second fluid jet axis in a co-planar alignment with said first fluid jet axis, said second fluid jet axis intersecting said first fluid jet axis in free space at a selected jet angle Θ;
at least one source of fluid under pressure in fluid communication with said chamber's fluid inlet;
wherein said fluid under pressure flows into said fluidic circuit and projects said first and second fluid jets into free space to impinge upon one another, and wherein said impinging first and second jets generate a full coverage sheet jet having a fan angle of approximately 360 degrees and having a selected thickness angle between 10 and 75 degrees.

2. The full coverage fluidic oscillator defined in claim 1 wherein said selected jet angle Θ is in the range of 150 degrees to 180 degrees.

3. The full coverage fluidic oscillator defined in claim 1 wherein a first branch vortex inducing structure comprises an inwardly projecting protrusion configured to throttle the flow of fluid through the first branch by creating a separation region in fluid flowing downstream of the protrusion, and wherein said first branch's fluid flow is thereby forced to oscillate such that the first fluid jet oscillates about the first fluid jet's axis.

4. The full coverage fluidic oscillator defined in claim 3 wherein a second branch vortex inducing structure comprises an inwardly projecting protrusion configured to throttle the flow of fluid through the second branch by creating a separation region downstream of the protrusion, and wherein said second branch's fluid flow is thereby forced to oscillate such that the second fluid jet oscillates about the second fluid jet's axis.

5. The full coverage fluidic oscillator defined in claim 4 wherein said first fluid jet and said second fluid jet each oscillate about their respective fluid jet axes, thereby causing a time varying shift in the impinging first and second jets and generating a full coverage sheet jet having selected thickness angle, where sheet jet thickness angle is controlled in response to first fluid jet oscillation amplitude and second fluid jet oscillation amplitude.

6. The full coverage fluidic oscillator defined in claim 1, wherein said first orifice and said second orifice are substantially circular in cross section.

7. The full coverage fluidic oscillator defined in claim 1, wherein said first branch has a proximal cross section that tapers to a smaller distal cross section that is smallest in area at the orifice, such that fluid flowing through the first branch flows at increased velocity at the orifice.

8. The full coverage fluidic oscillator defined in claim 1 wherein said fluidic circuit comprises an insert adapted for insertion into a slot defined in a housing or nozzle assembly.

9. The full coverage fluidic oscillator defined in claim 1 wherein said selected jet angle Θ is approximately 160 degrees.

10. The full coverage fluidic oscillator defined in claim 1 wherein said selected jet angle Θ is approximately 180 degrees.

11. The full coverage fluidic oscillator defined in claim 1 wherein said first branch and said second branch are part of a channel having a floor and sidewalls providing fluid passage connecting the inlet with said first and second branchs' distal orifices;
said channel further including a fluid path dividing barrier having a central axis and defining the first and second orifices, said barrier rising from the channel floor, with the barrier configured such that:
(i) said barrier divides the channel into said first and second branches;
(ii) each of the orifices define a jet axis at the orifice's distal end, each of said orifice jet axis being aimed or directed at an angle ξ with respect to said barrier centerline,
(iii) said barrier having a width that is characterized by the length B between the power nozzles' distal ends, and
(iv) wherein said barrier defines a concave boundary surface indented towards the oscillator's inlet between the orifices, so that the boundary surface is pulled back from the first and second fluid jets to cause unattached flow from the orifices.

12. The full coverage fluidic oscillator defined in claim 11 wherein said unattached flows promote the formation of oscillating first and second fluid jets, and permit said first and second fluid jets to have significant lateral motion to yield a thickness angle, θ, of between 10 and 75 degrees for the resulting sheet jet.

13. A method of generating a full coverage sheet jet of liquid comprising:
a) providing a fluid jet impingement intersection in free space;
b) projecting at least first and second oscillating fluid jets into said fluid jet impingement intersection at a selected jet angle relative to one another and generating a continuous collision of said oscillating jets in said impingement area in free space; and
c) issuing full coverage sheet jet of fluid from said impingement area.

14. The method defined in claim 13 wherein one of said pair of fluid jets is caused to have a different flow characteristic than the other of said fluid jets and causes said sheet jet to issue from said impingement area in a selected thickness angle in the range of 10 to 75 degrees.

15. An automated bowl cleaning system for unattended cleaning of the interior surface of a bowl or vessel, comprising:
(a) a pump configured to provide pressurized fluid at low pressure;
(b) said pump being configured to automatically be energized in response to a control signal from a timer or programmable controller;
(c) a single nozzle assembly adapted to be mounted within the rim of the bowl, proximate the bowl's upper circumferential rim, to hang above the bowl's interior surface;
(d) said nozzle assembly further comprising:
(i) a body member having a chamber therein, said chamber having a fluid inlet for receiving fluid under pressure and admitting it into said chamber and first and second fluid outlets for issuing first and second pressurized fluid jets from said chamber into an ambient environment, said inlet and said first and second outlets defining first and second flow paths therebetween for flow of fluid through said chamber; and
(ii) wherein said first pressurized fluid jet and said second pressurized fluid jet are aimed from opposing directions toward an impingement point at a jet angle of more than 150° and less than 180° to generate a sheet or resultant spray, such that the resultant spray is substantially omni-directional and wets the bowl's interior surface from said single nozzle assembly.

16. The automated bowl cleaning system of claim 15, wherein said pump is configured to be energized in response to a manually input control signal.

17. The automated bowl cleaning system of claim 15, wherein said nozzle assembly comprises oscillation-inducing means for causing the fluid jets issued from said first and second outlets to oscillate about their respective central axes, said oscillation-inducing means comprising surface means disposed in said flow paths and responsive to fluid from said inlet impinging thereon for establishing alternating vortices in said fluid downstream of said surface means; wherein said first pressurized fluid jet and said second pressurized fluid jet are aimed from opposing directions toward an impingement point at a jet angle of less than 180° to generate an oscillating sheet or resultant spray having a selected angular extent, such that the resultant spray is substantially omni-directional and wets substantially all the bowl's interior surface from said single nozzle assembly.

18. A nozzle assembly configured to generate a substantially omni-directional spray in a selected plane when pressurized by a low-pressure fluid supply, comprising:
(a) a chamber having a proximal fluid inlet for receiving fluid under pressure and first and second distal fluid outlets for issuing first and second pressurized fluid jets from said chamber into free space, said fluid inlet and said first and second outlets defining first and second flow paths therebetween for flow of fluid through said chamber; and
(b) wherein said first pressurized fluid jet and said second pressurized fluid jet are aimed from opposing directions toward an impingement point at a jet angle of more than 150° and less than 180° to generate a sheet or resultant spray, such that the resultant spray is substantially omni-directional in a selected plane.

19. The nozzle assembly of claim 18, wherein at least one of said fluid flow paths includes a vortex or oscillation-inducing means for causing the fluid jet issued from said outlet to oscillate about its respective central axis.

20. The nozzle assembly of claim 19, wherein said oscillation-inducing means comprises surface means disposed in said flow path and responsive to fluid from said inlet impinging thereon for establishing alternating vortices in said fluid downstream of said surface means.
